(19) United States
(12) Patent Application Publication
(10) Pub. No.: US 2010/0225811 A1
(43) Pub. Date: Sep. 9, 2010

(54) Synchronization of Content from Multiple Content Sources

(75) Inventor: Aaron B. Konvisser, San Diego, CA (US)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/398,309

(22) Filed: Mar. 5, 2009

(51) Int. Cl. H04N 9/475

(52) U.S. Cl. 348/512; 348/E09.034

(57) ABSTRACT

An event as defined by a place and a time may be captured by multiple devices or individuals. Storing time information in association with the content item allows users to identify content associated with that event or any event. Time data may be provided in varying time bases depending on the network from which time information is determined. Accordingly, all content capturing the same event may be synchronized and aligned appropriately by adjusting the various timing information to a common time base. The synchronization and alignment is facilitated by capturing content using very fine time bases that provides accurate time stamping of content. In one or more arrangements, timing information may be adjusted using a time almanac that uses sample timing data. The content may further be assembled into a content item that provides multiple perspectives of the same event.

### BACKGROUND

With the growing prevalence of hand-held or otherwise mobile devices capable of capturing different types of content, users are increasingly capturing video, audio and still images of various events. However, time stamps associated with the captured content are often generated based on the internal clocks of the devices, which may differ depending on the users' settings and in the case of connected devices, type of network. Accordingly, synchronization issues may arise between content recorded using a first time base and content recorded using a second time base. The lack of synchronization and a common time base may present difficulties in searching for, accessing and combining content items.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

One or more aspects relate to the recordation of timing information in content items. The timing information may be determined from a communication network, a location determination network (e.g., global position system), internal clocks and the like. The timing information may identify an absolute capture time (e.g., time of day) of the content item rather than a relative time (as is the case with videos always beginning at 0:00:00). Content items may further include other identification information including capture date, location and orientation.

According to another aspect, content items that include timing information based on disparate time bases may be synchronized to a common time base. For example, times recorded in a first time base may be converted using an adjustment value to a corresponding time in a common time base. The use of a common time base may allow two content items (e.g., video streams) to be combined to form a single video. Additionally or alternatively, a common time base provides a way to search for content without having to use different timing parameters for content item recorded using different time bases.

According to another aspect, a time base almanac may be created and maintained to aid in the conversion of time from a first time base to a second (e.g., common) time base. The time base almanac may be created by extracting timing information from content items captured with times using a network-specific time base and a common time base. The difference in the times may be calculated and used to convert other times captured using the same network-specific time base to the common time base. Time base almanacs may be created prior to the processing and synchronization of content items or on the fly as processing and synchronization is performed.

According to yet another aspect, a searchable database may be constructed storing content item information keyed to one or more of location, common time base time, network time, network type and orientation. Users or content servers may thus identify content related to the same event by querying the database.

### BRIEF DESCRIPTION OF THE DRAWINGS

Certain embodiments are illustrated by way of example and not limited in the accompanying figures in which like reference numerals indicate similar elements and in which:

FIG. 1 is a block diagram of an example communication network in which one or more embodiments may be implemented.

FIG. 2 is a block diagram of an example communication device according to one or more aspects described herein.

FIG. 3A illustrates a content capturing environment in which multiple capture devices are recording the same event according to one or more aspects described herein.

FIG. 3B is a block diagram of a content server according to one or more aspects described herein.

FIG. 3C illustrates an example synchronization of multiple video streams recording the same event according to one or more aspects described herein.

FIGS. 4A and 4B illustrate example misalignments between two content items according to one or more aspects described herein.

FIG. 5 illustrates a synchronization ambiguity existing between two content items according to one or more aspects described herein.

FIG. 6 illustrates a realignment process for synchronizing three video streams according to one or more aspects described herein.

FIG. 7 illustrates an example method for synchronizing differently time base stamped content according to one or more aspects described herein.

FIG. 8 illustrates an example method for resolving misalignments between content items according to one or more aspects described herein.

FIG. 9 illustrates an example network environment in which a time base almanac may be created according to one or more aspects described herein.

FIG. 10 illustrates an example time base almanac according to one or more aspects described herein.

FIG. 11 illustrates an example method for creating and maintaining a time base almanac according to one or more aspects described herein.

FIG. 12 illustrates an example data structure for storing timing and location information for a content item according to one or more aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

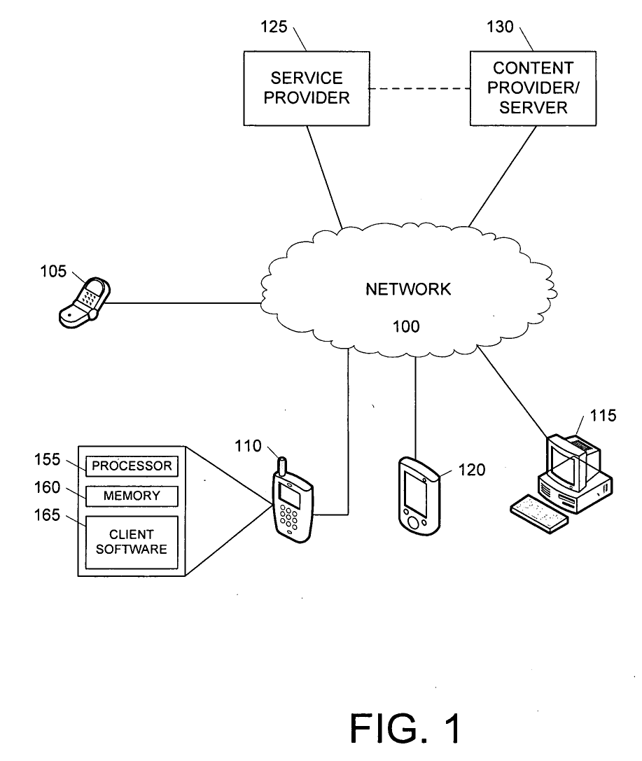

FIG. 1 illustrates an example communication network through which various inventive principles may be practiced. A number of computers and devices including mobile communication device 105, mobile phone 110, personal digital assistant (PDA) or mobile computer 120, personal computer (PC) 115, service provider 125 and content provider 130 may communicate with one another and with other devices through network 100. Network 100 may include wired and wireless connections and network elements, and connections over the network may include permanent or temporary connections. Communication through network 100 is not limited to the illustrated devices and may include additional mobile or fixed devices such as a video storage system, an audio/video player, a digital camera/camcorder, a positioning device such as a GPS (Global Positioning System) device or satellite, a television, an audio/video player, a radio broadcasting receiver, a set-top box (STB), a digital video recorder, remote control devices and any combination thereof.

Although shown as a single network in FIG. 1 for simplicity, network 100 may include multiple networks that are interlinked so as to provide internetworked communications. Such networks may include one or more private or public packet-switched networks, e.g. the Internet, one or more private or public circuit-switched networks, e.g. a public switched telephone network, a cellular network configured to facilitate communications to and from mobile communication devices 105 and 110, e.g. through use of base stations, mobile switching centers, etc., a short or medium range wireless communication connection, e.g. Bluetooth®, ultra wideband (UWB), infrared, WiBree, wireless local area network (WLAN) according to one or more versions of Institute of Electrical and Electronics Engineers (IEEE) standard no. 802.11), or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 105-120 may use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

Devices 105-120 may be configured to interact with each other or other devices, such as content server 130 or service provider 125. In one example, mobile device 110 may include client software 165 that is configured to coordinate the transmission and reception of information to and from content provider/server 130. In one arrangement, client software 165 may include application or server specific protocols for requesting and receiving content from content server 130. For example, client software 165 may comprise a Web browser or mobile variants thereof and content provider/server 130 may comprise a web server. Billing services (not shown) may also be included to charge access or data fees for services rendered. In one arrangement where service provider 125 provides cellular network access, e.g. acts as a wireless service provider, client software 165 may include instructions for access and communication through the cellular network. Client software 165 may be stored in computer-readable memory 160 such as read only, random access memory, writeable and rewriteable media and removable media in device 110 and may include instructions that cause one or more components—e.g., processor 155, a transceiver, and a display—of device 110 to perform various functions and methods including those described herein.

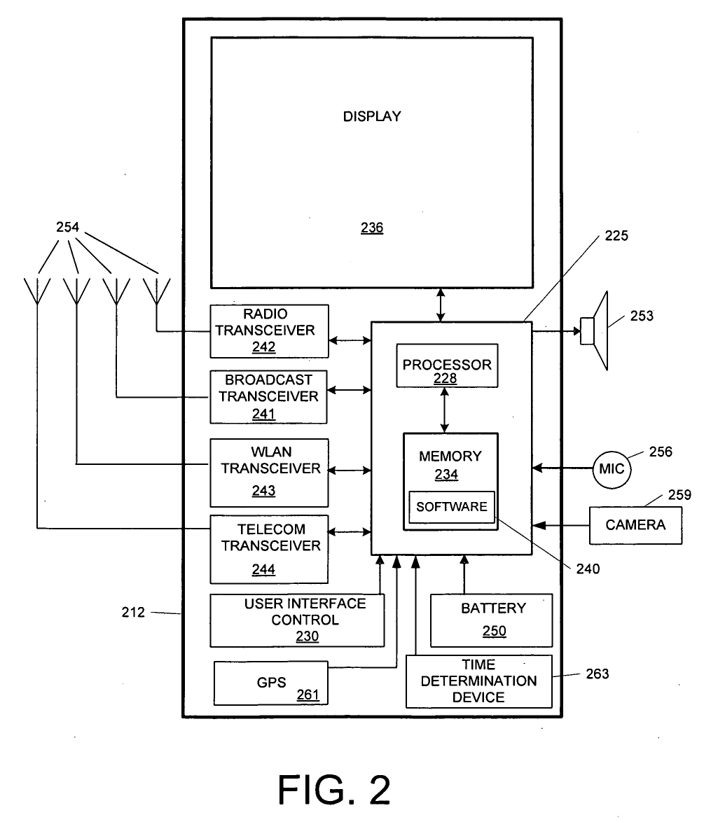

FIG. 2 illustrates an example computing device such as mobile device 212 that may be used in network 100 of FIG. 1. Mobile device 212 may include a controller 225 connected to a user interface control 230, display 236 and other elements as illustrated. Controller 225 may include one or more processors 228 and memory 234 storing software 240, e.g. client software 165. Mobile device 212 may also include a battery 250, speaker 252 and antenna 254. User interface control 230 may include controllers or adapters configured to receive input from or provide output to a camera 259, keypad, touch screen, voice interface—e.g. via microphone 256, function keys, joystick, data glove, mouse and the like. Additionally or alternatively, camera 259 and microphone 256 may be configured to capture various types of content including video, audio and still images.

Computer executable instructions and data used by processor 228 and other components of mobile device 212 may be stored in a storage facility such as memory 234. Memory 234 may comprise any type or combination of read only memory (ROM) modules or random access memory (RAM) modules, including both volatile and nonvolatile memory such as disks. Software 240 may be stored within memory 234 to provide instructions to processor 228 such that when the instructions are executed, processor 228, mobile device 212 and/or other components of mobile device 212 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like.

Mobile device 212 or its various components may be configured to receive, decode and process various types of transmissions including digital broadband broadcast transmissions that are based, for example, on the Digital Video Broadcast (DVB) standard, such as DVB-H, DVB-H+, or DVB-MHP, through a specific broadcast transceiver 241. Other digital transmission formats may alternatively be used to deliver content and information regarding availability of supplemental services. Additionally or alternatively, mobile device 212 may be configured to receive, decode and process transmissions through FM/AM Radio transceiver 242, wireless local area network (WLAN) transceiver 243, and telecommunications transceiver 244. Transceivers 241, 242, 243 and 244 may, alternatively, include individual transmitter and receiver components. In one or more arrangements, mobile device 212 may further include a gyroscopic sensor (not shown) configured to determine an orientation of mobile device 212. According to one or more further aspects, mobile device 212 may include a GPS device for receiving and determining location information from one or more GPS satellites. GPS device 261 may further be configured to determine an absolute time (e.g., a time of day) for a location of the mobile device 212. Alternatively or additionally, a time determination device 263 may be used to calculate a local device time of device 212 using information from GPS 261 or other network signals (e.g., from transceiver 242, 243 or 244).

Although the above description of FIG. 2 generally relates to a mobile device, other devices or systems may include the same or similar components and perform the same or similar functions and methods. For example, a stationary computer such as PC 115 (FIG. 1) may include the components or a subset of the components described above and may be configured to perform the same or similar functions as mobile device 212 and its components.

Mobile device 212 of FIG. 2, PC 115 of FIG. 1 and other computing devices may often be configured to capture content such as video, images, text and audio. The increasing prevalence of mobile capture devices (such as camera phones and camcorders), in particular, has led to increasing ease in capturing various occasions and events. However, in many instances, users may be dissatisfied with the quality, views or length of content captured. While other users may have captured the same event with better quality, different views or lengths, the dissatisfied users might not have knowledge of those individuals or their content. By recording location and real time (e.g., time of day) information in content items, a user may be able to locate other content of the same event to replace or supplement the user's own content. Content such as videos may also be synchronized and mixed together to offer multiple perspectives of an event at a particular moment in time. For example, a first user might only have recorded the first 5 minutes of a speech while a second user was able to record a second 5 minutes of the same speech. By synchronizing and mixing the two content items together, a user may view the whole speech.

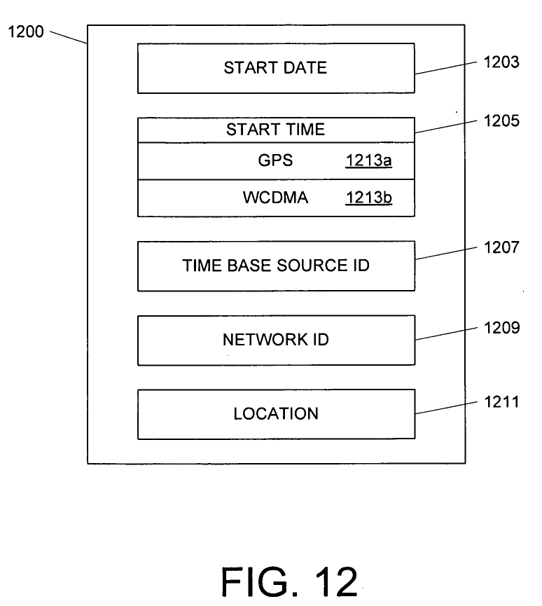

In one or more arrangements, a real time common time base may be used for indicating a capture time of content so that timing information of multiple content items may be synchronized to the same time scale. Real or true time, as used herein, generally refers to time as expressed as a time of day rather than a relative time (e.g., time relative to the beginning of a content item). For example, many content capturing devices capture content such as video using a time base that sets the start of the video as 0:00:00. Instead of using such a relative time stamp, a real or true time base may sets the start of the video as the time of day at which the video was captured, e.g., 1:03:30.0343 PM. FIG. 12 illustrates a data structure for storing time and location information for a content item such as a video. Data structure 1200 may be a header packet in a content stream, header information in a content file, metadata of a content file, a descriptor file associated with a content file and the like. Data structure 1200 may include a start date 1203 of the content, a true start time 1205, a time base source identifier 1207, a network identifier 1209 and location information 1211. The true start time 1205 may include one or more start times 1213 depending on a number of time sources available to the device capturing the content. For example, true start time 1205 may include a GPS start time 1213a and a WCDMA start time 1213b. Time base source identifier 1207 specifies the type or types of time bases in which the true start time 1205 is expressed. Network identifier 1209 is configured to specify the network to which the capture device is connected. For example, the network identifier 1209 may include a GSM network code, a System Identification (SID)/Network Identification (NID) for CDMA networks and the like. Location information 1211 may be expressed in terms of latitude and longitude, zipcode, postal address, zone number and the like.

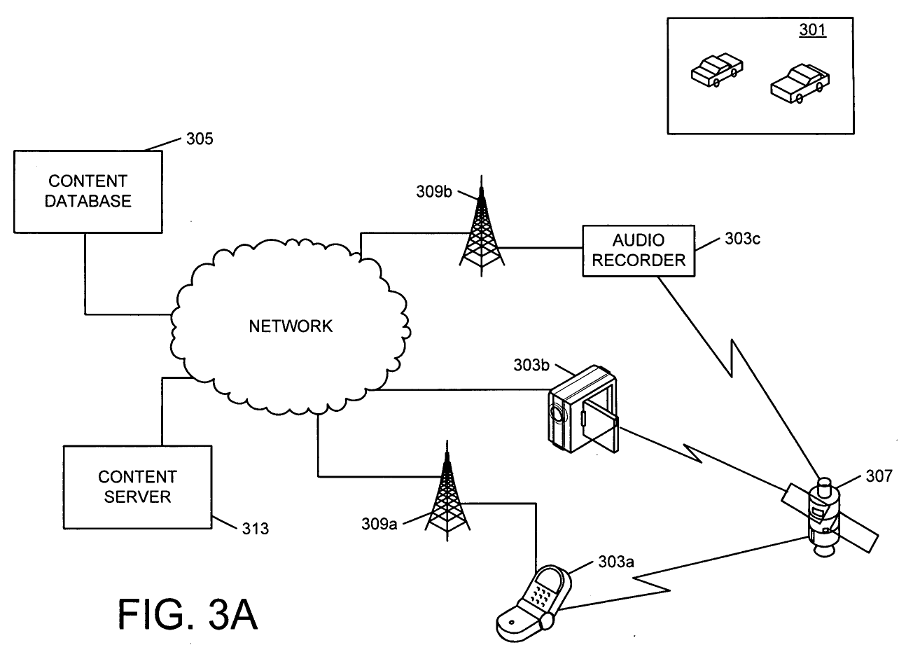

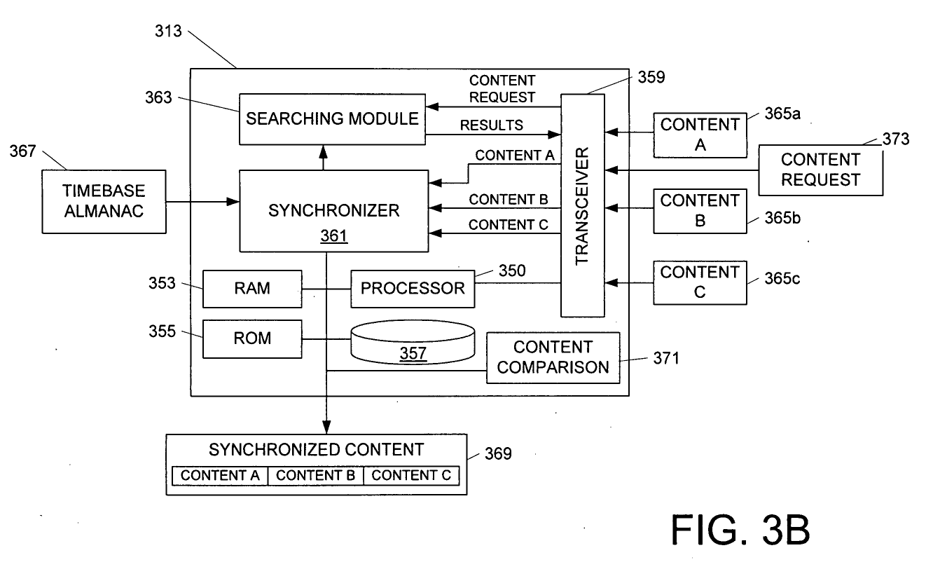

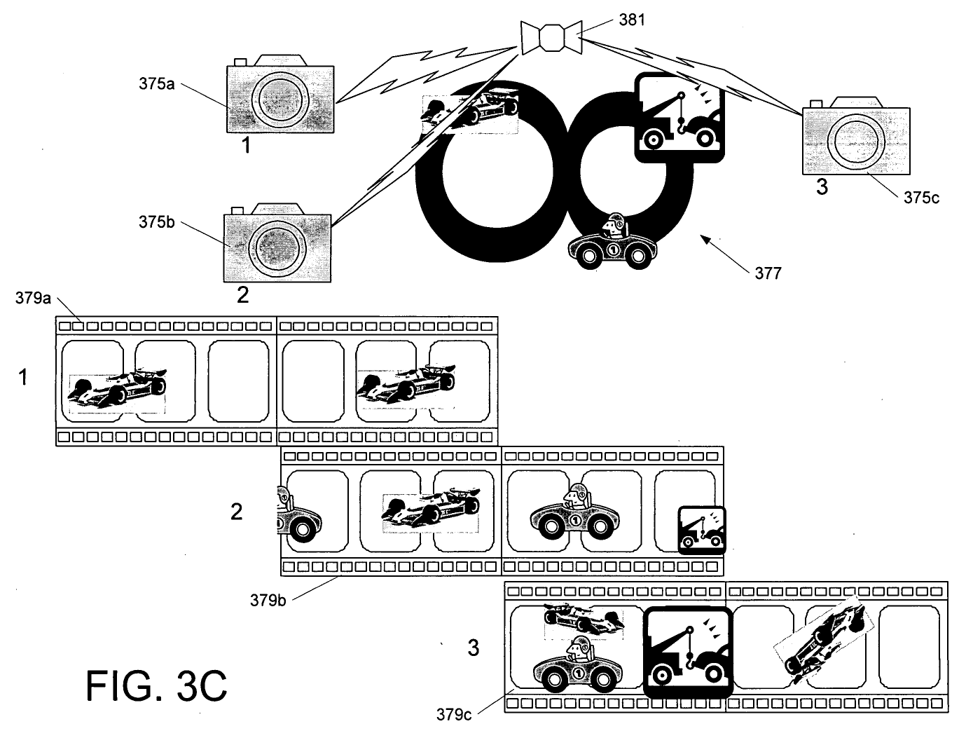

FIG. 3A illustrates an example environment in which multiple content capturing devices (e.g., mobile device 212 of FIG. 2) are capturing the same event 301. An event may generally refer to a particular combination of location and time. An event may further be defined by a length of time and orientation among other parameters. Camcorder 303b, for example, may be capturing video from a first vantage point while camera phone 303a may be capturing video or still images of the same event from a second vantage point. Additionally, audio recorder 303c might only have audio recording capabilities and thus record only an audio stream of the event. Each of devices may include, in addition to their content capturing components, a location detection device (e.g., GPS 261 of FIG. 2) and a time determination device (e.g., device 263 of FIG. 2). In one or more arrangements, location detection and time determination may be facilitated by the same device or component. For example, a global positioning system (GPS) device may be used to identify device 303b's location in addition to a current time. GPS devices are generally synchronized to an atomic clock located in GPS satellites such as satellite 307. By calculating the time it takes for a signal to travel from the satellite to the device, a content capturing device can determine a local device time as well as the device location (e.g., via trilatteration techniques). Additionally or alternatively, timing information may be determined based on a network time specified by communication networks 309 or from an internet based time server. Each of networks 309 may generate timing information based on different time bases or the same time base.

Once determined, each device may store location and time information associated with content in a content file along with the captured content. Location and time may be stored as metadata, header information or in some other data container. The content files may then be transmitted to content database 305. Alternatively or additionally, content may be transmitted to database 305 in a concurrent or streaming fashion (e.g., a video may be transmitted as it is being recorded). In one or more streaming arrangements, each frame, as it is captured, may be sent to database 305 as the next frame is being captured. Transmission of each frame, partial frame or group of frames may be preceded by header information that includes location and time data. Database 305 may store the content in a database that may be keyed according to location, time, date and orientation (e.g., an angle at which a video was captured). By keying database 305 in such a manner may allow a user to search for content corresponding to a particular location or time or both. Database 305 may include a single database located at a particular site or may comprise a distributed database that spans multiple devices and locations. Alternatively, database 305 may include a peer-to-peer network where content is stored locally on each device (e.g., devices 303) and shared through a master index.

Content server 313 may be configured to facilitate the processing of content requests including identification and retrieval of matching content, storage and keying of content, mixing and synchronization of multiple content items, maintenance of a time almanac and the like. FIG. 3B illustrates an example content server 313. Content server 313 may include various components and devices including a processor 350, RAM 353, ROM 355, database 357, transceiver 359, synchronizer 361 and searching module 363. Content items 365 may be received through transceiver 359 and delivered to synchronizer 361 for processing. Synchronizer 361 may extract timing information from content items 362 and convert the timing information to a common time base using a time almanac 367. A time almanac generally refers to a database or other information storage structure that provides conversion data for converting times of one time base (e.g., WCDMA time base) to another (e.g., GPS time base). Time almanacs such as time almanac 367 are described in further detail below. In one example, synchronizer 361 may piece together several content items to provide a complete rendering of a particular event as a single content item 369 and transmit such to a requesting user. Searching module 363, on the other hand, may be configured to process content requests, whether the requests are internal or received from an external source. For example, synchronizer 361 may request content matching a received content item from searching module 363. Alternatively, users submit content requests (e.g., request 373) based on various parameters including location and time. Upon determining one or more search parameters, searching module 363 may access an internal database 357 or external database 305 (FIG. 3A) to identify and retrieve matching or similar content. Content server 313 may also include a content comparison module 371 configured to determine a similarity between two content items. For example, content comparison module 371 may determine whether two content items correspond to the same event based on location and timing information or, alternatively or additionally, based on image analysis. Content server 313 may further provide an interface through which content may be shared publicly or privately (e.g., among friends or other types of groups).

Synchronization between content items is often used to correctly align content items to a common time scale or base and to each other. For example, if gaps exist between frames of one or more videos or if a video frame begins prior to the end of another frame, the video may exhibit shakiness or blurriness. In another example, misalignment may cause audio to be out of synch with video, i.e., the audio being played might not correspond to the portion of the video being rendered. Misalignment often becomes relevant when two content items are to be mixed or otherwise associated with one another. Because content items may be synchronized to different network time bases at capture, the content items might not align correctly if mixed using their network-specific timing information. GPS systems, for example, may have a time base granularity of approximately 340 ns while WCDMA systems may use a time base of 3.84 Mcps (chips per second). Chips per second refer to a number of time ticks per second. Thus, a 3.84 Mcps (e.g., as used by WCDMA) corresponds to a time base granularity of 3.84 million time ticks every second. CDMA systems, on the other hand, may use a time base of 1.228 Mcps. Accordingly, to synchronize multiple content items such as video or audio of disparate time bases, a common time base may be selected and used. In particular, the timing information for each of the content items to be synchronized may be modified to conform to the common time base and adjusted for alignment issues.

FIG. 3C illustrates an example scenario where multiple content capture devices 375 (such as devices 303 of FIG. 3A) are recording the same event 377. The videos 379 captured by the cameras 375 are time coded using GPS time (using GPS satellite 381) so that videos 379 may be accurately aligned as illustrated. Synchronization, alignment and mixing may performed by a synchronization server or device such as server 313 of FIG. 3B. Once aligned the video of the entire event can be edited including cut between multiple views such as the accident towards the end.

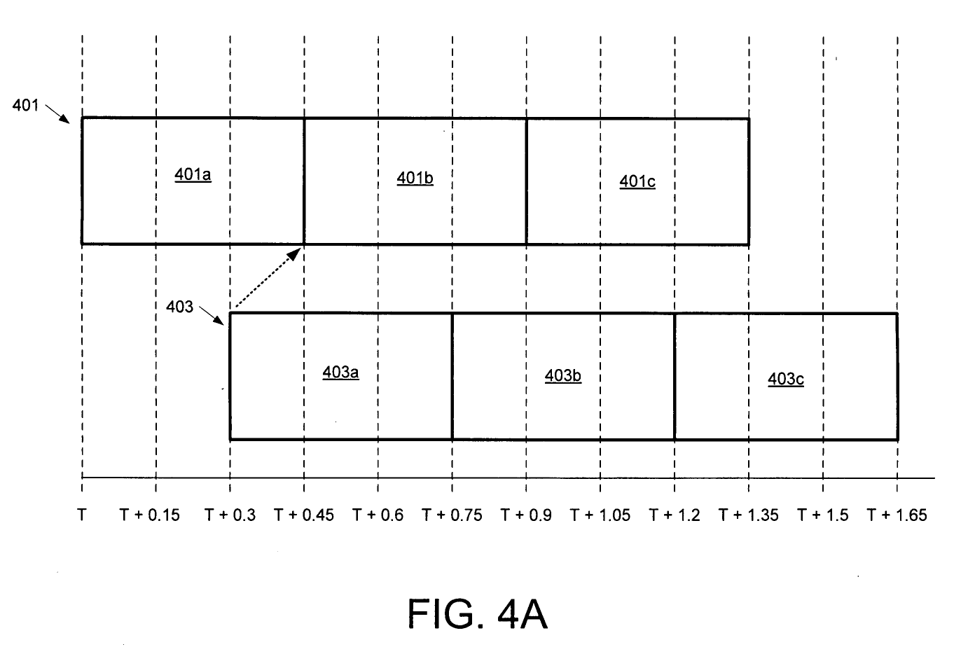

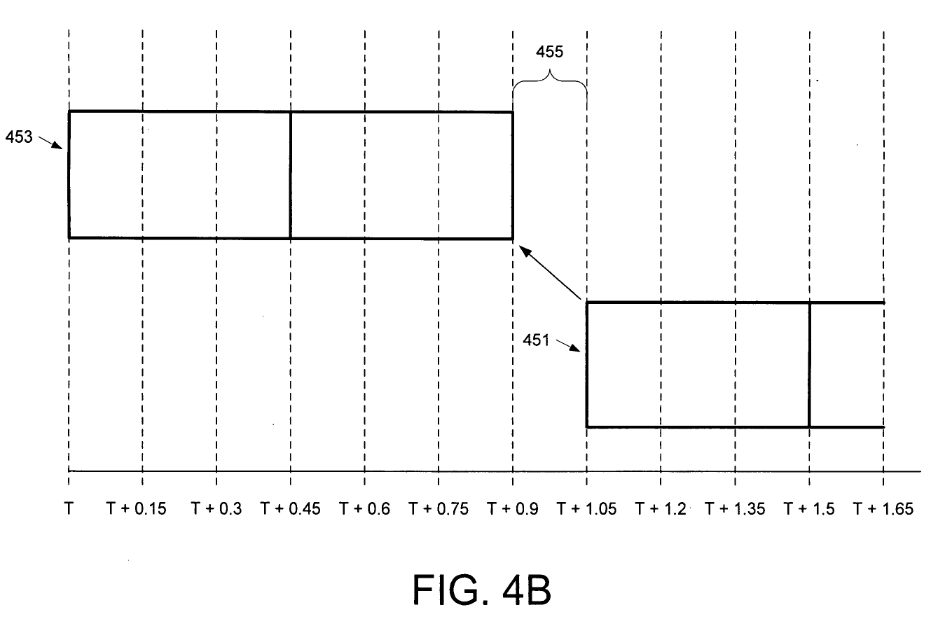

FIG. 4A illustrates an example misalignment of two video streams, each having multiple frames of similar frame length. Assume that video 401 and video 403 both have frame lengths of 0.045 seconds. Further assume that video 401 has been recorded based on a time base having a 0.015 second granularity while video 403 has been recorded using a time base having a 0.045 second granularity. Stated differently, video 401 's time base is defined by a smallest unit of time of 0.015 sec while video 403's time base is defined by a smallest unit of time of 0.045 seconds. Thus, in one example, even though video 403 might have been captured beginning at an absolute time of 0.03 seconds past midnight, the start time might be recorded as midnight since video 403's time base has a granularity of only 0.045 seconds. The start time of video 401, midnight, is represented by time T. If video 401 was similarly recorded starting at 0.03 seconds past midnight, start time data associated with video 401 may accurately indicate a 0.03 seconds past midnight start time because of the finer granularity of video 401's time base.

In the above illustrated example, frames of video 403 do not align with the frames of video 401. That is, frame 403a, for example, does not align with either the beginning or end of frame 401a. Thus, if videos 401 and 403 were to be mixed (e.g., to allow a user to switch between different perspectives provided by the two videos), frame 401a would be incompletely rendered prior to the start of frame 403a, thereby leading to display errors. To avoid such issues, video 403 may be snapped or synchronized to video 401's time base or vice versa. Accordingly, in one example, frame 403a may be snapped to either a midnight start time (to match the beginning of frame 401a) or a midnight+0.045 second start time (to match the end of frame 401a and the beginning of frame 401b) depending on whether the recorded start of frame 403a is temporally closer to the beginning of frame 403a or the end. Since frame 403a begins at 0.03 seconds past midnight, frame 403a and the rest of video 403 may be realigned by +0.015 seconds (i.e., frame 403a would be adjusted to a 0.045 sec past T). So long as the frame lengths of each of videos 401 and 403 are the same, synchronizing the first frame 403a of video 403 would result in the appropriate alignment of all other frames in video 403 as well. The example time bases used herein may be much greater than those used in practical applications where time base granularity may be much finer (e.g., GPS, CDMA, WCDMA).

FIG. 4B illustrates another example of video misalignment where the beginning of video 451 does not match up with the end of video 453. That is, a gap 455 in time exists between the two videos 451 and 453. In such an instance, video 451 may be shifted forward such that the beginning of video 451 matches the end of video 453. Alternatively, if the gap is above a certain threshold, video 451 might not be moved (i.e., to preserve the gap).

According to one or more aspects, video may be encoded at frame rates of 60 frames per second (fps) or lower. Some video may be interlaced which indicates that 50% of the pixels on a display or in a video are updated each cycle. Accordingly, the effective frame rate for some videos may be 30 frames per second with every other pixel being updated on alternate 30 fps cycles. Progressive video formats, however, may have an effective frame rate of 60 fps because all pixels are updated in the frame at once. This is but one example of a video format that may be synchronized according to aspects described herein. Other video formats may also be synchronized and modified.

The same or similar synchronization methods may be used to synchronize content other than video including audio content and still images. For example, two audio streams may be captured using disparate time bases. Accordingly, a common time base may be selected to mix the audio streams. In another example, a still image may be mixed with a video. In such a case, a common time base may be selected and the still image and the video may be synchronized to the common time base. In yet another example, an audio stream may be synchronized to a video to provide audio for a speech along with captured video.

In one or more arrangements, a common time base may have a level of granularity where the beginning of a time interval is located exactly halfway between the beginning and the end of a frame. For example, if a frame length is 0.5 seconds, using a time base of half the frame length, or 0.25 seconds, provides the potential for a frame of a first video beginning exactly in the middle of a frame of a second video. This may lead to synchronization ambiguities.

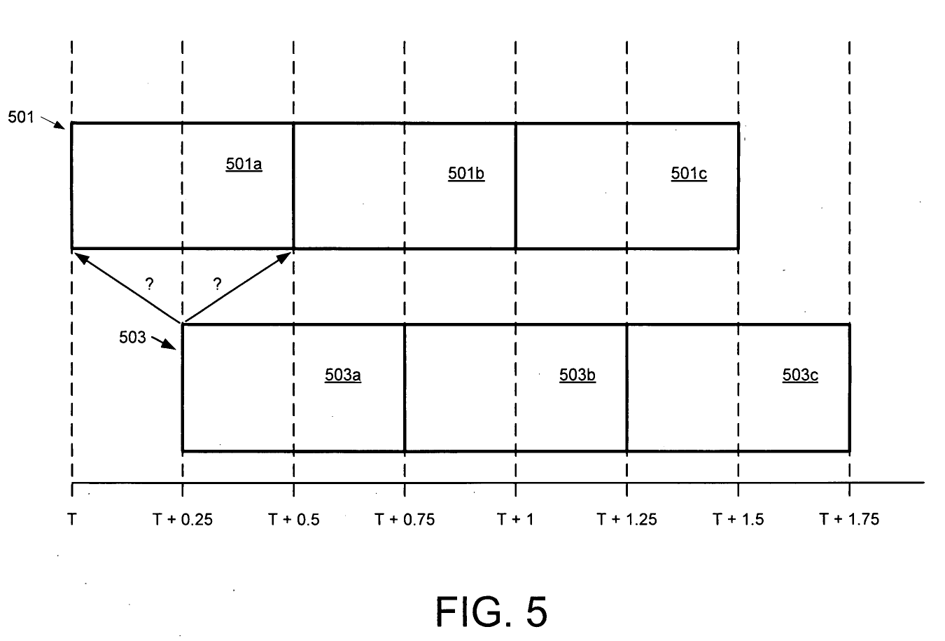

FIG. 5 illustrates such an example time base scenario. Because the frames of video 503 are offset by half the frame length of frames of video 501, it might not be possible to determine which direction to snap or synchronize frames of video 503 simply based on, e.g., whether the beginning of frame 503a is closer to the beginning or end of frame 501a of video 501. Accordingly, one or more rules may be implemented to resolve such ambiguities. For example, a synchronization system such as synchronizer 361 (FIG. 3B) may specify that frames are to be snapped to the end of a reference frame (i.e., video frame to which the current frame is being synchronized) in such instances. In another example, a rule may specify that frames such as frame 503a are to be snapped to the beginning of the reference frame (e.g., frame 501a). Other parameters and variables may also be considered and used to develop such synchronization rules.

Alternatively or additionally, synchronization systems may be instructed to avoid selection of a common time base where a time interval would fall at a midpoint of a reference frame. For example, a common time base that corresponds to ⅓ of a frame length may be used as illustrated in FIG. 4. Time bases may be selected such that the frame length is equally divisible by the selected time base (e.g., ⅕ frame length, 1/7 frame length, 1/9 frame length, etc.). Alternatively, the frame length might not be equally divisible by the time base.

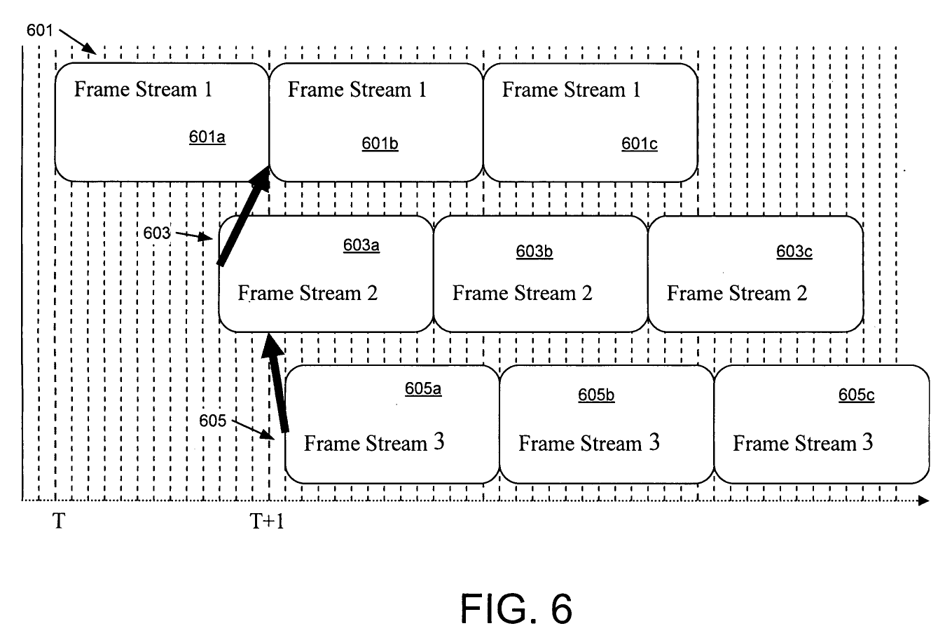

FIG. 6 illustrates the synchronization of three video streams using another example common time base. Each of the frames of videos 601, 603 and 605, respectively, are of length 1, while the selected common time base is 1/13 of the frame length. When synchronizing videos 601, 603 and 605 to the common time base, video 601 may be used as a reference video to which each of videos 603 and 605 are synchronized. Accordingly, since each of videos 603 and 605 do not align with either the beginning or end of one of frames 601, realignment may be performed. In the example of video 603, because frame 603a begins closer to the end of frame 601a (i.e., the beginning of frame 601b), frame 603a may be snapped to time T+1, where T corresponds to the start time of reference video 601. Since the first frame 605a begins after and closer to the beginning of the second frame 601b, frame 605a may also be snapped to or realigned with time T+1. One of the advantages of using a non-even time base (i.e., where an odd number of time intervals correspond to the frame length) is that a frame (e.g., frame 603a or 605a) will not fall at an exact midpoint of a reference frame (e.g., frame 601a) and introduce synchronization ambiguity as described above.

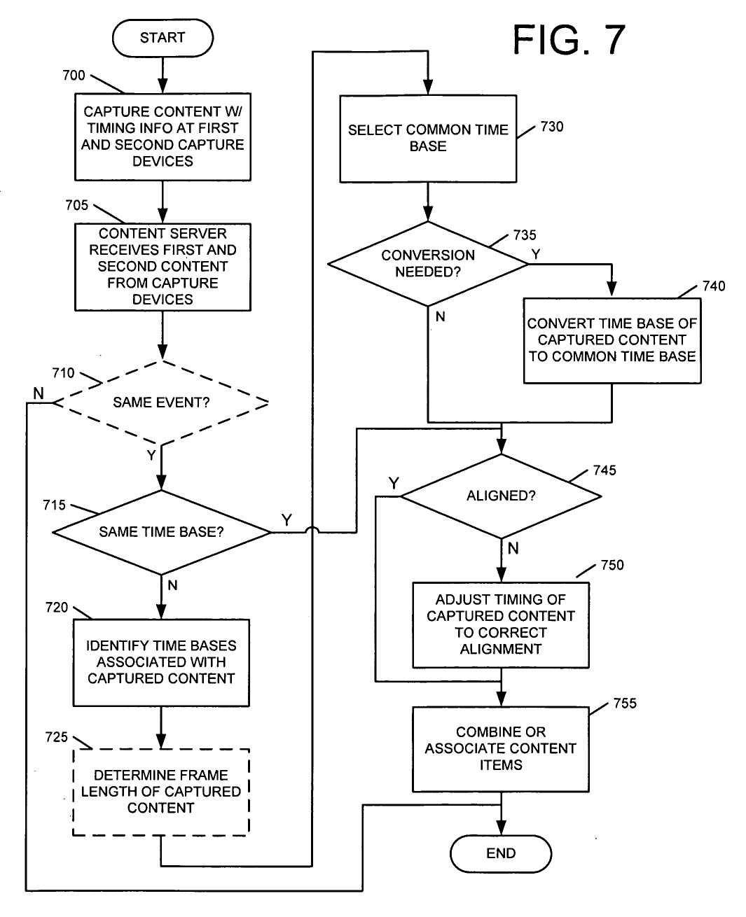

FIG. 7 illustrates an example method for synchronizing differently time base stamped content such as video, audio, images and the like. In step 700, a first content capture device may capture first content using a first time base while a second content capture device may capture second content using a second time base. In step 705, a content server may receive each of the first content and the second content along with capture time information. In one example, the captured content may be received as content files having metadata specifying a capture time, location, orientation and the like. In one or more arrangements, the content server may determine whether the first content and the second content correspond to the same event or location in step 710. Whether the first and second captured content correspond to the same event may be determined based on time stamps, orientation data and/or location information recorded by the capture device. For example, the content items may be determined to correspond to the same event if the content items correspond to locations within 0.1 miles of each other and capture times that are within 30 minutes of one another. One or more of steps 715-755 may be taken in response to determining the first and second content correspond to the same event. Alternatively, steps 715-755 may be performed regardless of whether the content corresponds to the same event.

In step 715, the content server may determine whether the first content and the second content are synchronized to the same time base. This may be determined by identifying the time base source (e.g., time base source identifier 1207 of FIG. 12) for each of the first and second content. If so, the first and second content may be combined or otherwise associated with one another without further modification to the timing information in step 715. If, however, the first and second content items are not synchronized to the same time base, the content server may identify the time base associated with each content item in step 720. Optionally, in the case of video, the content server may also determine a frame length associated with the videos in step 725. In step 730, the content server may select a common time base for synchronizing the two content items. The selection may be made based on a level of granularity, an amount of conversion needed and the like. For example, the content server may select a time base that has the finest level of granularity for precise time keeping. In another example, the content server may select a time base that would place the least amount of processing load on the system. In yet another example, the level of granularity and the conversion processing load may both be taken into account and a time base may be selected based on a balance of the two factors.

Upon selecting the common time base, the content server may determine whether conversion is needed for one or more of the content items in step 735. Conversion might not be needed if the common time base selected is a time base to which one or both of the content items are already synchronized. If conversion is needed for one or more of the content items, the content server may convert the time base of the one or more content items to the common time base in step 740. The conversion may be facilitated by a time base almanac that provides a look-up table where a time according to a first time base is associated with a corresponding time in a second time base. Thus, if a capture device records the start time of a video according to a WCDMA time base, the content server may use the time base almanac to look up a corresponding GPS time. Time base almanacs are described in further detail below.

Once the time bases have been converted for the two content items (if necessary), the content server may determine whether the content items (or portions thereof) are aligned in step 745. Alignment may be evaluated based on whether a first content item or a portion thereof begins within the body of another content item or portion thereof, whether a gap of a specified size exists between the end of a first content item and the beginning of a second content item and the like. For example, the start and end times of the content items (e.g., a video stream, an audio stream, a frame of a video, etc.) may be compared in view of a content item length (e.g., video or frame length) to identify such misalignments. Accordingly, if a first video begins at 2:00:00:00 PM and has a frame length of 0.5 seconds and a second video begins at 2:00:00:02, a synchronization system may determine that the second video begins after the beginning but prior to the end of a first frame of the first video. In another example, if a first video begins at 2:15:00 and has a video length of 30 minutes and a second video begins at 2:45:15, a synchronization system may determine that a gap of 15 seconds exists between the end of the first video (i.e., 2:15:00+30 minutes=2:45:00) and the beginning of the second video.

According to one or more arrangements, if a gap between two content items exists and the gap is less than a threshold size, the content items may be aligned such that one is aligned to begin immediately after the other. If the content items are aligned correctly, the content server may combine or otherwise associate the two content items in step 755. If, on the other hand, the content items are not aligned, the content server may adjust the timing of one of the two content items to correct for the misalignment in step 750. Correction of misalignments is described in further detail below. Upon modifying the alignment of the content items, the content items may be combined or otherwise associated in step 755.

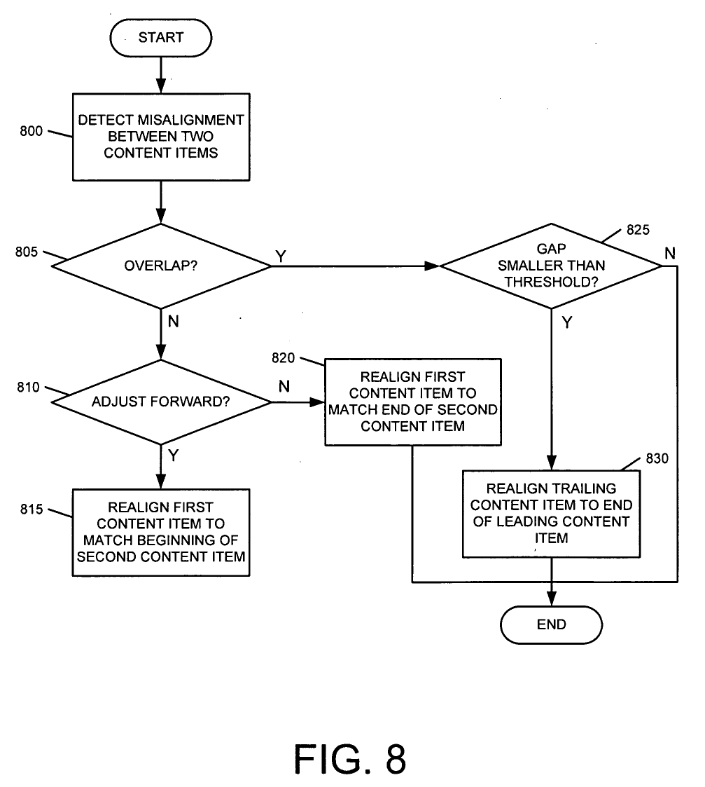

FIG. 8 illustrates an example method through which misalignments may be resolved. In step 800, a misalignment may be detected between two content items by analyzing the timing information and content lengths of each content item as described herein. In step 805, a system may determine whether the misalignment is due to an overlap between two content items. If so, the system may then determine whether to adjust a first content item forward to match a beginning or end, respectively, of a second content item (or portion thereof) in step 810. The determination may involve determining whether the first content item is temporally closer to the beginning or the end of the second content item. If the first content item is closer to the beginning of the second content item, the first content item may be realigned to match the beginning of the second content item (i.e., shifted forward in time) in step 815. In one example, the start time of the first content item may be modified to match the start time of the second content item. Alternatively, if the first content item is closer to the end of the second content item, the first content item may be realigned to match the end of the second content item in step 820. In one or more arrangements, alignments may be performed at a frame level such that the beginning of a frame of a first content item is evaluated against a beginning or end of a frame of a second content item. For example, if a first frame of a first video begins during a third frame of a second video, a determination may be made as to whether the first frame of the first video should be snapped to a beginning or end of the third frame of the second video. Accordingly, videos might not be snapped to the absolute beginning or end of another video; rather, videos may be aligned with the beginning or end of a frame of a reference video regardless of the position of the reference frame (i.e., the reference frame may be in the middle of the reference video).

If, on the other hand, the misalignment is due to a gap between two content items, the system may determine whether the gap is smaller than a threshold gap in step 825. The threshold gap may be 1 second, 0.5 seconds, 2 seconds, 0.25 seconds, 0.00001 seconds or the like. The threshold may be set such that meaningful or substantial gaps are maintained between videos or content items. If the gap is smaller than the threshold gap, the system may snap the beginning of the trailing content item to the end of the leading content item in step 830. Snapping may include the modifying of the start time of the trailing content item to match the end time of the leading content item. If, however, the gap is longer than the threshold gap, the content items might not be modified. The above process may be performed for pairs of content items. For example, if 3 videos are to be synchronized, a first and second video may be aligned according to the process of FIG. 8. The first and third videos (or, alternatively or additionally, the second and third videos) may then be aligned using the same process. This ensures that all three videos will be properly aligned and synchronized.

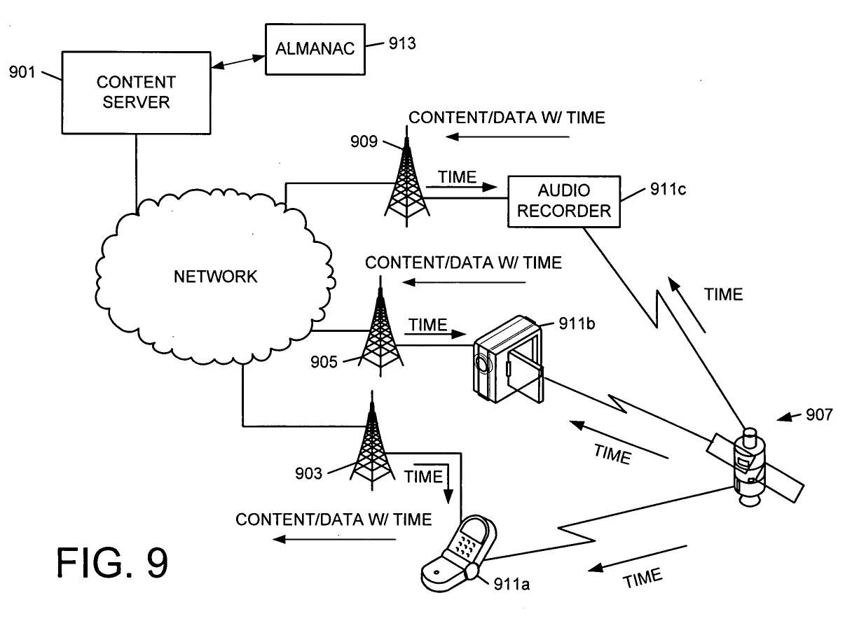

FIG. 9 illustrates an example network environment in which a time base almanac 913 may be created and maintained. The network environment may include multiple types of networks such as CDMA 903, WCDMA 905, GPS 907, GSM 909. To create a time base almanac such as almanac 913, a synchronization system or content server 901 may receive content or data from devices 911 on each of the networks 903, 905, 907 and 909 that specify a time in their own network time base as well as a common time base. For example, if GPS timing is used as the common time base, devices 911 which have connections to both a network such as CDMA 903, WCDMA 905 and GSM 909 as well as a connection to GPS system 907 may provide timing information in both time bases. Thus, content server 901 may be able to determine that 1 Mcps past 1:00 PM corresponds to 1:00:03:25 in GPS time based on data received from device 911a. By capturing such timing information for multiple media samples or other types of data (e.g., text messages, e-mails, etc.), content server 901 may create almanacs providing a look-up table for converting times in one time base to another time base. An almanac may be keyed to location, date, common time base (e.g., GPS) time, network information (e.g., network type) and network time. Almanacs may also be generated by special purpose hardware and/or software. For example, a WCDMA carrier may decide to create an almanac by placing GPS receivers at a few points in their network and collecting timing samples. Alternatively or additionally, an application may be transmitted to mobile devices using the network. The application may then periodically or aperiodically take data samples of location, GPS time and network time and send this back to a server for creation of an almanac.

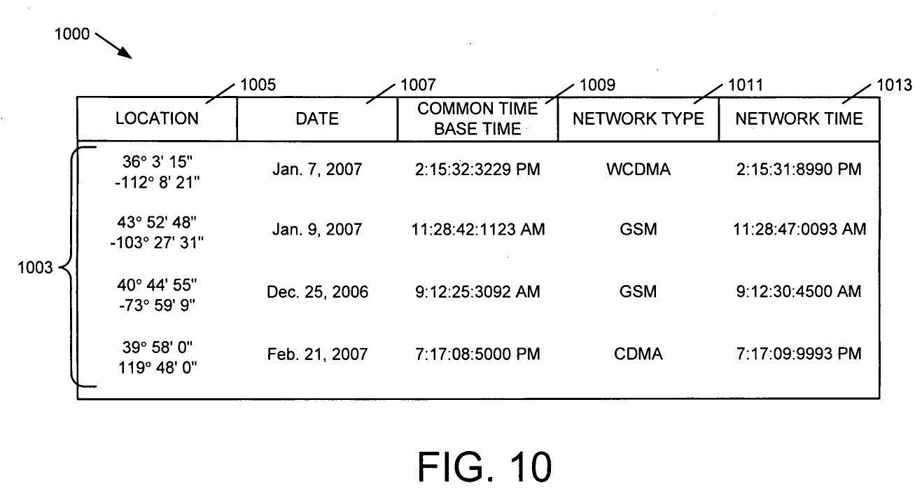

FIG. 10 illustrates an example time base almanac. Almanac 1000 may comprise a table in which time samples are shown in rows 1003. Each sample may include location information 1005, date 1007, common time base time 1009, network type 1011 and network time 1013. Almanac 1000 may be searchable by any of the above data parameters. Accordingly, a device or a content server may identify timing samples based on network type 1011 or location 1005, for example. Almanacs may be created or updated continuously, based on a schedule or in a one-time manner (i.e., a static almanac once created).

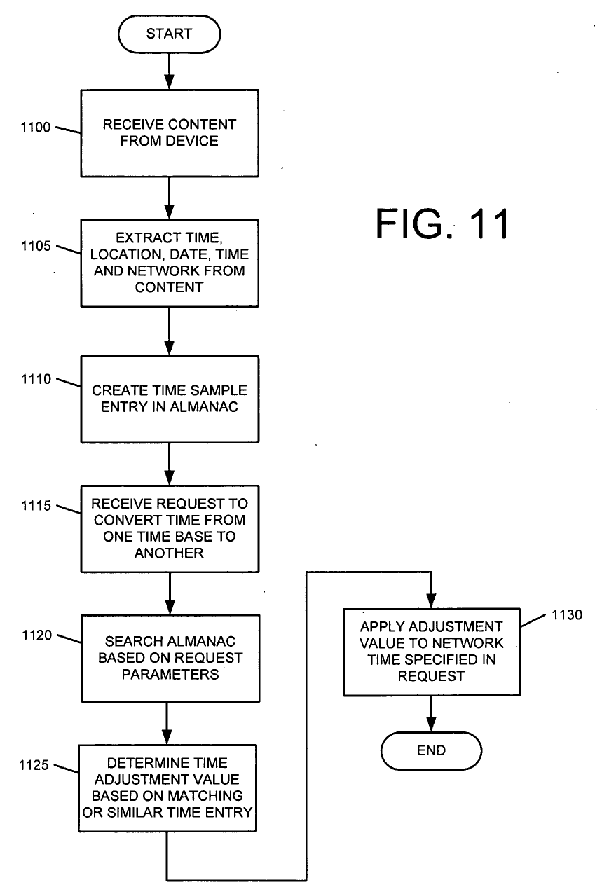

FIG. 11 illustrates an example method for creating and maintaining a time base almanac. In step 1100, a content server may receive content from a device. The content may include timing information stored as part of a media sample, a text message, an e-mail or other communications. The timing information may include time data according to a first time base and time information according to a second time base. In step 1105, the content server may extract time, location, date, time and network information from the content. In step 1110, the content server may create a time sample entry in the almanac and store the extracted information in the entry.

In step 1115, the content server may receive a request to convert a time from one time base to another. For example, the request may indicate a time in WCDMA that needs to be converted into a GPS time. In step 1120, the content server may search the almanac based on one or more parameters such as network type and network time. In one example, the content server may identify one or more entries for the network type and for a closest matching time. Once the content server has identified a matching or similar time entry in the almanac, the content server may determine an adjustment value based on the entry's network time and common time base time in step 1125. For example, if the entry specifies a network time of 10:15 and a corresponding common time base time of 10:17, the content server may determine that the network time should be adjusted by +00:02. In step 1130, the adjustment value may be applied to the network time specified in the request to produce a common time base time. Alternatively or additionally, one or more of the time adjustment value and identified time entry information may be provided to a requesting device.

According to one or more aspects, an almanac may be created on the fly. For example, an almanac may be constructed in response to a request for converting timing information. Specifically, a content server may poll devices connected to a specified network type for timing information. The content server might only poll those devices that are also connected to a network using a specified common time base.

Content items may be stored in a database by a content server or other repository as they are captured. The content items may be stored based on an index keyed to date, time, location, orientation or the like. In one or more configurations, time information may be modified so that a capture time of each content item is identified using a common time base. By indexing the content items, the database or other content repository may be searchable. For example, a user may request content for 12:00:00 PM on Jan. 20, 2009 at the Mall in Washington, D.C. Using these parameters (i.e., time, date, location), the content server may search a content database for matching or similar content. Similarity may be defined by a time, location or orientation threshold. For example, content that was captured within 15 minutes of 12:00:00 PM on Jan. 20, 2009 might still be considered relevant or similar to the request parameters. In another example, content that is 0.1 miles away from the Mall in Washington, D.C. may also be considered similar or relevant to the request and returned as a search result. Various algorithms and parameters may be used for searching such a database.

The process of capturing location and time information, synchronizing timing data, creating a time base almanac and providing a searchable database of content may also be used separately or in various combinations and sub-combinations. Thus, the synchronization of content times may be used in various systems independently of the capturing and storage of location and timing data. Similarly, a searchable database of content may be provided and used independently of content synchronization.

Aspects described herein may include embodiments such as a method comprising storing, at a device, captured content in a content file; determining a time at which the content is captured based on timing information from a network to which the device is connected; and storing the capture time in the content file. Additionally or alternatively, the storing of the captured content may include storing the video in the content file and storing information indicating one or more of a network type of the network and a time base source in the content file. The timing information may be generated from a time base that is defined based on a time of day (i.e., true time). The time base may have a granularity in the milliseconds, microseconds, nanoseconds or finer.

Another embodiment may include one or more computer readable media (e.g., memory in an apparatus or stand-alone media) storing computer readable instructions that, when executed, cause an apparatus to store, captured content in a content file; determining a time at which the content is captured based on timing information from a network to which the device is connected; and storing the capture time in the content file. The storing of the captured content may include storing the video in the content file and storing information indicating one or more of a network type of the network and a time base source in the content file. The timing information may be generated from a time base that is defined based on a time of day (i.e., true time).

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, digital signal processors (DSPs), field-programmable gate arrays (FPGAS), controllers, application-specific integrated circuits (ASICS), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

We claim:

1. A method comprising:
determining, by a device, a first time at which a first content item was captured, wherein the first content item is captured using a first time base defined by a first number of time units per second and a time of day; and
modifying, by the device, the first capture time of the first content item in accordance with a second time base, the second time base defined by a second number of time units per second of time different from the first number of time units per second.

2. The method of claim 1, further comprising:
determining a second time at which a second content item was captured, wherein the second capture time conforms to a third time base defined by a third number of time units per second; and
modifying the second capture time in accordance with the second time base, wherein the third time base is different from the second time base.

3. The method of claim 2, wherein the first content item includes a first video and the second content item includes a second video and wherein the method further comprises:
determining that a frame of the first video is misaligned with a frame of the second video;
determining whether a beginning of the frame of the first video is temporally closer to the beginning of the frame of the second video; and
in response to determining that the beginning of the frame of the first video is temporally closer to the beginning of the frame of the second video, realigning the beginning of the frame of the first video to match the beginning of the frame of the second video.

4. The method of claim 3, wherein determining that the frame of the first video is misaligned with the frame of the second video includes determining that the frame of the first video begins after the beginning and prior to the end of the frame of the second video.

5. The method of claim 3, wherein determining that the first frame is misaligned with the second frame includes determining that a gap exists between the beginning of the first frame and the end of the second frame.

6. The method of claim 2, further comprising:
receiving the first content item from a first device synchronized to a first communication network; and
receiving the second content item from a second device synchronized to a second communication network different from the first communication network.

7. The method of claim 6, further comprising:
determining that the first content item and the second content item correspond to a location; and
in response, combining the first content item and the second content item in accordance with their respective capture times to produce a third content item.

8. The method of claim 1, further comprising:
storing the first content item in a database, wherein storage is keyed to at least one of: the first capture time, a capture location of the first content item, a capture date and an orientation of a device with which the first content item was captured;
receiving a request for content corresponding to a time and a location; and
identifying the first content item as a match for the request from the database based on at least one of the request time and the request location matching the first capture time and the capture location, respectively.

9. The method of claim 1, further comprising:
determining a second time at which a first content item was captured, wherein the second capture time conforms to the second time base; and
storing the first capture time in association with the second capture time in a look-up table.

10. The method of claim 9, further comprising:
receiving a request to convert a third capture time from the first time base to the second time base;
determining an adjustment value based on the first capture time and the second capture time; and
generating a fourth capture time in the second time base corresponding to the third capture time by modifying the third capture time by the adjustment value.

11. The method of claim 1, further comprising selecting the second time base based on a frame length of a video in the first content item, wherein the frame length comprises an odd number of time units.

12. An apparatus comprising:
a processor; and
memory storing computer readable instructions that, when executed, cause the apparatus to:
determine a first time at which a first content item was captured, wherein the first content item is captured using a first time base defined by a first number of time units per second and a time of day; and
modify the first capture time of the first content item in accordance with a second time base, the second time base defined by a second number of time units per second of time different from the first number of time units per second.

13. The apparatus of claim 12, wherein the computer readable instructions, when executed, further cause the apparatus to:
determine a second time at which a second content item was captured, wherein the second capture time conforms to a third time base defined by a third number of time units per second; and
modify the second capture time in accordance with the second time base, wherein the second number of time units per second is different from the third number of time units per second.

14. The apparatus of claim 13, wherein the computer readable instructions, when executed, further cause the apparatus to:
receive the first content item from a first device synchronized to a first communication network; and
receive the second content item from a second device synchronized to a second communication network different from the first communication network.

15. The apparatus of claim 14, wherein the computer readable instructions, when executed, further cause the apparatus to:
determine that the first content item and the second content item correspond to a location; and
in response, combine the first content item and the second content item in accordance with their respective capture times to produce a third content item.

16. The apparatus of claim 12, wherein the computer readable instructions, when executed, further cause the apparatus to:
store the first content item in a database, wherein storage is keyed to at least one of: the first capture time, a capture location of the first content item, a capture date and an orientation of a device with which the first content item was captured.

17. The apparatus of claim 12, wherein the first content item includes audio.

18. One or more computer readable media storing computer readable instructions that, when executed, cause an apparatus to:
determine a first time at which a first content item was captured, wherein the first content item is captured using a first time base defined by a first number of time units per second and a time of day; and
modify the first capture time of the first content item in accordance with a second time base, the second time base defined by a second number of time units per second of time different from the first number of time units per second.

19. The one or more computer readable media of claim 18, wherein the computer readable instructions, when executed, further cause the apparatus to:
store the first content item in a database, wherein storage is keyed to at least one of: the first capture time, a capture location of the first content item, a capture date and an orientation of a device with which the first content item was captured.

20. The one or more computer readable media of claim 18, wherein the computer readable instructions, when executed, further cause the apparatus to select the second time base based on a frame length of a video in the first content item, wherein the frame length corresponds to an odd number of time units.
